(19) United States
(12) Patent Application Publication
(10) Pub. No.: US 2014/0376247 A1
(43) Pub. Date: Dec. 25, 2014

(54) DEVICE FOR MAKING THE APPEARANCE OF A MOTOR VEHICLE SIGNAL LIGHT UNIFORM

(71) Applicant: AUTOMOTIVE LIGHTING REAR LAMPS FRANCE S.A.S., Saint-Julien-du-Sault (FR)

(72) Inventor: Alain Buisson, Trappes (FR)

(73) Assignee: Automotive Lighting Rear Lamps France S.A.S., Saint-Julien-du-Sault (FR)

(21) Appl. No.: 14/375,527

(22) PCT Filed: Jan. 30, 2013
(86) PCT No.: PCT/EP2013/051737

§ 371 Date: Jul. 30, 2014

(30) Foreign Application Priority Data
Jan. 30, 2012 (FR) 1200270

(51) Int. Cl. F21S 8/10; F21K 99/00

(52) U.S. Cl. CPC F21S 48/2268; F21K 9/52; F21S 48/215; F21S 48/2212; F21S 48/2237; F21Y 2101/02
USPC 362/511

(57) ABSTRACT

The invention relates to a device for a motor vehicle signal light (1), of the type having built-in light guides (3) and comprising at least one LED (2) as a light source. The device (1) comprises a part (5) made from translucent material, positioned in front of the guide (3) in the direction of travel of the diffused light and provided with graining to provide a light function of uniform colour.

The current invention relates to vehicle lighting and signalling, notably for motor vehicles. It relates more particularly to a device for a vehicle signal lamp comprising a guide arranged to be able to guide and diffuse the light emitted by at least one LED, and in front of it an element of transparent material intended, in combination with said guide, to homogenize and/or adjust the light emitted by the device.

The regulations in force require, dependent on the vehicle type, different lighting or signal lamps. But aside from the volume of the lamp assembly, the performance and uniformity of illumination of individual lamps grouped in this way are major concerns.

Auxiliary transparent screens are known from the prior art in which the light emitted by an auxiliary light source can propagate, these screens being intended to equip a lamp, notably a rear lamp, of a motor vehicle. Local discontinuities provided in the material of the screen comprise focal points for diffusion of the light outside these screens (see the published French patent No. 2 868 506).

The German patent application DE 101 01 795 describes flashing lamps, notably for the front indicator lamps for motor vehicles, in which a source of auxiliary light for the position lamp illuminates an element positioned transversely in the space between the main lamp and the front lens, and obtains via this lens lighting in the same direction as that of the main lamp.

In French patent application 01 00048, published under number 2 819 040, there is a description of an optical or style component for lighting or signalling of motor vehicles. This component is of a transparent material, on the inside of which focal points for diffusion of the light are situated solely in predetermined locations to diffuse the light emitted by a source associated with the lighting or signalling device in question. This component may constitute the lens of a floodlight of a motor vehicle or an insert placed in such a floodlight.

German patent application DE 103 11 317 describes a vehicle lighting device comprising a light guide with diffusive structures essentially located at the focus of reflective surfaces which thus allow the diffusion of a homogeneous light.

The applicant has likewise designed, and described in the document FR 2 953 781 A1, a new device for a motor vehicle lamp, comprising a transparent optical material and at least one LED type light source arranged to emit light rays propagating within the thickness of said transparent optical material, which essentially comprises:
a plate of transparent optical material forming a curtain,
said plate comprising at least a bilateral elongated thickening with an essentially overall circular cross-section, having its mean longitudinal axis in the middle plane of said plate and suitable for forming a light guide, and
at least one LED placed at at least one of the ends of said light guide, with its main axis orthogonal to longitudinal axis of said light guide.

In these miscellaneous applications and miscellaneous embodiments of luminous screens diffusing the light emitted by at least one LED, inhomogeneities can appear in the diffused light, particularly close to the guides, including those which can be provided with diffusive curtains or screens.

It therefore appeared appropriate to attempt to homogenize the light output from such lamps having a light guide or to mask any inhomogeneities that might occur.

The subject of the present invention is a device for a motor vehicle lighting and/or signal lamp incorporating a guide, as defined above and in the description that follows.

The present invention thus concerns a device for a motor vehicle lighting and/or signal lamp incorporating a guide and in which a transparent or translucent element or screen is combined with the aforementioned guide, whatever the type of guide, the element or screen being essentially comprised of an opaline type material, provided with internal and/or external graining and arranged between said guide and the visible face of the lamp or of the assembly lamps concerned, in order to provide a light function of uniform color.

The front part forming the translucent screen provided with graining of the intended type is located downstream of the light guide associated with at least one LED, in the sense of diffusion of the light emitted by the LED(s). Its effect and/or purpose is to homogenise the light output of said curtain and thus suppress diffusion irregularities, hence the aspect which light originating from such light guides can present.

Thus a subject of the invention is a lamp for a motor vehicle, of the type having a guide for diffusion of the light emitted by at least one LED suitable for illuminating perpendicular to at least one of the lateral faces of said guide, while the latter is completed by a translucent material element, arranged frontally between the face of the guide turned towards the front face of the projector concerned and the exterior, effectively perpendicularly to the main direction of the light beam. This element is thus intended to at least partially cover the face defining the lighting of said light guides for lighting by LED of motor vehicles.

In a preferred embodiment, the aforementioned translucent material element is a part made from opaline or at least primarily opaline indeed a part having optical characteristics substantially like those of opaline or an equivalent translucent material.

This part can constitute an additional element of a signal lamp device for vehicles. As a variant it can comprise the lens of the optical housing comprising other functional elements of such a vehicle signal lamp.

In all cases, said graining can be provided on the external face and/or the internal face of such an element, or indeed on the inside of the latter. It is preferred that said graining is applied to the internal face of the aforementioned element when it is integrated in an appropriate housing.

It will be shown below that said element grained in this way is advantageously arranged in front of the aforementioned guide, with a space between them.

In the present description, graining is taken to mean the forming of discontinuities in and/or on the material concerned. Conventionally, grained material can then be produced:
without addition or removal of material, by suitable treatment of all or part of the inner wall of the manufacturing mold of the element to be grained, and/or
by addition of reactive material suitable for generating inclusions in the material serving to create a grained opaline screen, under the conditions of production of the latter, in both cases using techniques known by a person skilled in the art, who knows how to allow for the roughness requirements imparted upon the element added to the guide.

In practice the material rendered opaline is made of PMMA or poly(methyl methacrylate) to which is added, for example by injection, materials chosen from amongst the material microbeads that have an opalescent effect and a dispersive material, notably for the injection and distribution of a gas, notably CO₂, to give the opalescence produced a random character.

The opaline material can be left off-white or be colored, notably to appear amber colored or super-light blue, using techniques known to a person skilled in the art. It can thus allow another effect to be provided in the illuminated state in which the color of the light emitted by the LEDs can thus be different from the color in an extinguished state.

The opaline material part has dimensions making it possible for it to conform with the dimensions of the aforementioned light guides.

In practice the light guides used can have a length (straight or curvilinear) of approximately 200-300 mm when they are illuminated by an LED at one of their ends, and even up to approximately 600 mm if they have an LED at each of their two ends.

One would expect that it would be easier to glue said translucent element to the light guide. However it emerged that on the contrary, for good distribution and effective conservation of the transmitted light intensity, a certain distance should be maintained between the light guide and said translucent element.

In practice, the aforementioned opaline material is advantageously fixed at a distance from the above-described light guide. Preferably it is placed in front of this guide in the path of the trajectory of the diffused light, at a distance which in practice is between approximately 5 and 10 mm, more preferably between 6 and 9 mm, and more advantageously between approximately 7 and 8 mm The fastening of this element close to the ends of the aforementioned guide or to any other support which may be available nearby is performed without difficulty by conventional means within the scope of a person skilled in the art.

In the implementation of the present invention, there is moreover a considerable freedom in the choice of shapes to fulfill the requirements of the desired design function.

Likewise it must be noted that, in such a configuration, the inventive lighting device guide becomes akin to a filament of a virtual light source.

The aforementioned translucent element cooperates with the other elements of the lighting device to produce an overall effect which can be conveniently adapted, notably by the choice of the geometry, the distance to the guide and/or the translucency characteristics of said element.

The inventive device is primarily intended to equip lighting systems forming side marker lamp, stop lamp, high-mounted stop lamp, indicator and/or possibly a front daytime running lamp of motor vehicles.

Dependent on the application, the thus designed translucent element is in practice crystal-colored, red or another color. It can comprise two parts, totally overlapping each other or preferably partially overlapping each other, of which one retains a crystal color while the other is colored red or otherwise.

The invention will be better understood and its other objectives, advantages and characteristics will become more apparent under the spotlight of the following detailed description of inventive embodiments.

These embodiments are purely illustrative and non-limiting although drawing plates are attached to said description in which:

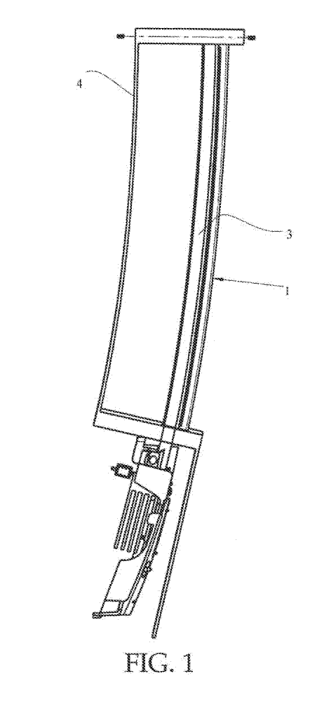

FIG. 1 represents a schematic plan view of a motor vehicle rear lamp 1 not equipped with an inventive opaline grained element.

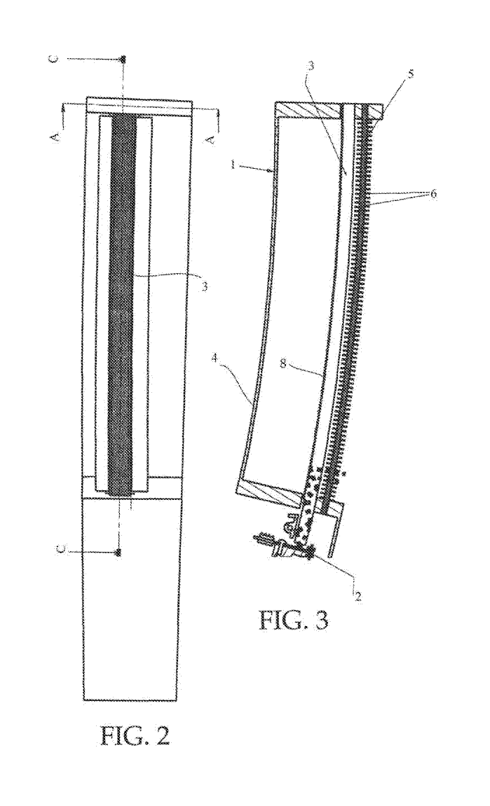

FIG. 2 represents a front schematic view of the device according to FIG. 1, but provided with the element 5 with inventive graining 6.

FIG. 3 is a schematic view of a longitudinal section along C-C of the inventive device, integrated in an assembly as schematically depicted in FIG. 2.

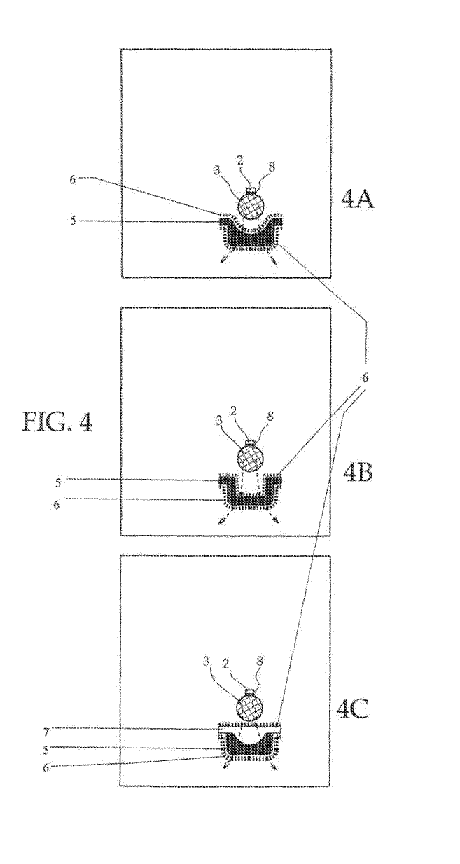

FIG. 4 (FIGS. 4A, 4B, 4C) represents a partial schematic cross-section along A-A of a lighting device, including a translucent material part 5 provided with graining 6 according to FIG. 2.

In the embodiment represented in the attached figures, the device forming the inventive rear lamp 1 of the motor vehicle thus combines with a guide 3, advantageously incorporated in a structure or housing 4 and suitable for being illuminated by a light source 2, a translucent screen 5 provided with graining 6.

Moreover an external, transparent screen can be provided by the cover of the housing containing the lighting lamp device.

Thus the invention relates preferentially to a motor vehicle lamp, of the type having a guide 3 for diffusion of the light emitted by at least one LED 2 illuminating perpendicularly to at least one of the lateral faces of said guide 3, comprising moreover a screen 5 of translucent material provided with graining 6, arranged frontally between the face of the guide 3 turned towards the front face of the projector concerned and the exterior, effectively perpendicularly to the main direction of the light beam.

Advantageously the device has, as a light source, one or more LEDs 2 of which the light beam is channeled by a guide 3 of the type mentioned above, and scattered by this guide (provided with appropriate cavities/surface irregularities, conventionally comprised of several prismatic units, designed or integrated by the means and according to the provisions known by a person skilled in the art) in a curtain 4. The inventive device 1 has been shown to achieve, as its main positive effect, the homogenisation of the lighting provided by these elements, both in line with this assembly of elements and at an offset viewing angle.

The intensity of the light thus better diffused and better distributed has been maintained at a satisfactory level taking into account the standards in force.

The profile of a mean cross-section of said part forming the translucent curtain may be of any shape; preferably it is similar or equivalent to one of those illustrated by way of example in FIG. 4 (see 4A, 4B and 4C). It can thus, for example, and without being limited to such a shape, have a recessed profile with a rounded internal bottom turned towards the bead forming the light guide 3, or a U-section of a width that can vary between approximately 10 and 25 mm or indeed a recessed profile of which the rounded bottom is overlaid by a covering plate 7 having graining elements 6 suitable for providing it with an opalescence. As for the guide 3, on its rear part it has conventional lenses 8.

According to one embodiment, the inventive device comprises a part as described above, having an elongated shape with a length of approximately 210-310 or 610 mm and a width of approximately 10-20 mm, preferably about 15 mm.

Such a part with a U-section of approximately 15-25 mm width constitutes an appropriate means for conferring the style or signature effects on the lighting device.

In the cases thus presented as illustrative examples, as in other cases, the opalescent part covering the light guides is preferably made opalescent on its outer surfaces, in such a way that the incident rays are diverted by the elements providing the opalescence and are thus diffused according to a wider and more homogeneous spatial distribution.

1. A device for a motor vehicle lighting and/or signal lamp incorporating a light guide (3) in which a translucent screen (5) is combined with said guide (3), said translucent screen being provided with graining (6) and arranged between said guide and the visible face of the lamp or of the assembly of lamps concerned, in order to provide a light function of uniform color.

2. The device as claimed in claim 1, in which the translucent screen (5) is provided with graining (6) on one or the other or both of its main faces suitable for being passed through by the light emitted by one or multiple LEDs (2).

3. The device as claimed in claim 1 or 2, in which said screen of translucent material (5) is a part made from opaline or primarily opaline or indeed a part having optical characteristics substantially like those of opaline or an equivalent translucent material.

4. The device as claimed in any one of claims 1 to 3, in which the graining (6) of the translucent screen (5) is internal and/or external to the material of said translucent screen.

5. The device as claimed in any one of claims 1 to 4, characterized in that the translucent screen (5) is composed of polymethyl methacrylate to which is added, for example by injection, materials chosen amongst the material microbeads that have an opalescent effect and a dispersive material, notably for the injection and distribution of a gas, notably CO₂, to give the opalescence produced a random character.

6. The device as claimed in any one of claims 1 to 5, characterized in that the opaline-type translucent material (5) is left off-white.

7. The device as claimed in any one of claims 1 to 5, characterized in that the translucent material (5) is colored, notably to appear amber colored or super-light blue, and allows another effect to be provided in the illuminated state in which the color of the light emitted by the LEDs can thus be different from the color in an extinguished state.

8. The device as claimed in any one of claims 1 to 7, characterized in that the translucent material part (5) is essentially fixed against said guide (3).

9. The device as claimed in any one of claims 1 to 7, characterized in that the translucent material part (5) is placed in front of said guide (3), advantageously at a distance of about 5 to 10 mm from said guide.

10. The device as claimed in any one of claims 1 to 9, characterized in that the translucent screen (5) has a recessed profile with a rounded internal bottom turned towards the bead forming the light guide (3), or a recessed profile of which the rounded bottom is overlaid by a covering plate (7) having graining elements (6) suitable for providing it with an opalescence, or indeed a U-section of a width than can vary between approximately 15 and 25 mm

11. The device as claimed in any one of claims 1 to 10, characterized in that it is used to equip lighting systems forming side marker lamp, stop lamp, high-mounted stop lamp, indicator and/or possibly a front daytime running lamp of motor vehicles.

12. A lamp for a motor vehicle, of the type having a guide (3) for diffusion of the light emitted by at least one LED (2) illuminating perpendicularly to at least one of the lateral faces of said guide (3), characterized in that it comprises moreover a screen (5) of translucent material provided with graining (6), arranged frontally between the face of the guide (3) turned towards the front face of the projector concerned and the exterior, effectively perpendicularly to the main direction of the light beam.
